(19) United States
(12) Patent Application Publication
(10) Pub. No.: US 2014/0085631 A1
(43) Pub. Date: Mar. 27, 2014

(54) DEVICE FOR THE HIGH-RESOLUTION MAPPING AND ANALYSIS OF ELEMENTS IN SOLIDS

(71) Applicants: Jean-Luc Lacour, Villebon-Sur-Yvette (FR); Nadége Caron, Versailles (FR); Kévin Beranger, Senlis (FR)

(72) Inventors: Jean-Luc Lacour, Villebon-Sur-Yvette (FR); Nadége Caron, Versailles (FR); Kévin Beranger, Senlis (FR)

(21) Appl. No.: 13/820,985

(22) PCT Filed: Sep. 6, 2011
(86) PCT No.: PCT/EP2011/065356

§ 371 Date: Oct. 18, 2013

(30) Foreign Application Priority Data
Sep. 6, 2010 (FR) 1057060

(51) Int. Cl. G01N 21/71

(52) U.S. Cl. CPC G01N 21/718
USPC 356/316

(57) ABSTRACT

A device is provided for mapping and for analysis of at least one element of interest included in a solid sample by laser-induced plasma optical emission spectrometry, enabling a high-resolution mapping, notably of elements such as hydrogen and oxygen, and is applicable to the fields of the nuclear industry and of aeronautics, and notably offers the advantage of not requiring costly installations. In one of the embodiments of the invention, a simultaneous mapping of elements such as hydrogen, oxygen and/or lithium is notably achievable.

The present invention relates to a high-resolution mapping and analysis device of elements in solids. It is more particularly applicable to elemental analysis of hydrogen and of oxygen by laser-induced plasma optical emission spectrometry, in the field of the nuclear industry, or else of the aeronautics or space industry.

In applications such as the characterization of devices subjected to radioactive sources, or else the characterization of the susceptibility to aging of devices employed in particularly harsh environments, for example in aircraft or space vehicles, it may prove to be indispensable to carry out the elemental analysis of samples. It may notably be sensible to perform the elemental analysis of the hydrogen and of the oxygen present in samples of radioactive materials. More precisely, it may prove to be necessary to be able to map the locations of these elements within the sample under analysis. Such an analysis can prove to be notably particularly useful in fragilization studies of metals by hydrogen, or else in studies of the aging of fuel cladding in the presence of oxygen, or again in studies of fragilization of fuel cladding caused by the formation of hydrides, the latter promoting the propagation of cracks.

Various known methods exist for mapping elements present in samples.

A first known method for the mapping of hydrogen or of oxygen consists in using a nuclear microprobe, whose operation is based on the nuclear interaction of a beam of helions with a target sample. The only method of direct analysis allowing hydrogen to be mapped with a high sensitivity and with a high-resolution, typically of around 2×8 pmt, is the method commonly designated according to the acronym ERDA for ‘Elastic Recoil Detection Analysis’. According to the ERDA method, the beam of incident ions penetrating into the sample interacts with the nuclei of the atoms comprising the latter, thus causing the emission of a recoil atom. This interaction, which extends from the surface of the sample down to around a micron in depth, means that this method allows the problem of surface contaminants to be avoided. For example, in the case of the mapping of hydrogen, since the ion-hydrogen interaction cross-section is very weak, according to this method, a mapping of hydrogen of 300×300 pmt can typically be carried out in a time of around 2 to 3 hours. The hydrogen thus probed is detectable starting from a concentration of around 30 ppm by mass, and in an absolute manner. This method does however have a certain number of drawbacks in that it requires a vacuum chamber for the analysis, and in that it implements devices belonging to the family of instruments known as ‘large instruments’, access to which may be subject to approval by a scientific commission.

A second known method for mapping of elements consists in using an electron microprobe, whose operation is based on electron-material interactions, via a beam of electrons collimated onto the surface of the sample. This method is only used in a local manner, on samples for which the elements of the matrix have an atomic mass that is very different from that of hydrogen. Thus, an elemental analysis via this method does not allow hydrogen to be detected. This is because electron microprobe analysis cannot allow the detection of elements lighter than oxygen since the latter are hardly or not at all observable, on the one hand, due to technological limits notably associated with the detectors employed, and, on the other hand, because of physical phenomena coming into play, notably X-ray absorption.

A third known method for mapping of elements such as hydrogen or oxygen is secondary ion mass spectrometry, commonly designated by the acronym SIMS. According to this method, ions bombard the surface of a sample, the bombardment leading to the erosion of the sample by sputtering of the atoms. The sputtered atoms are ionized than characterized in a mass spectrometer. This method allows a surface analysis with a high sensitivity, typically enabling detection limits of the order of 10⁻⁷%, or 1 ppb, to be attained, with a lateral resolution of less than the hundred nanometer level. This method does however have a certain number of drawbacks, notably in that it needs to be implemented in a high vacuum, involving risks of degassing of non-bonded water from the sample, which is enough to affect the measurement of the hydrogen initially present.

One method that may also be mentioned is for routine analysis of the distribution of hydrides, consisting in analyzing an image following metallographic preparation of a sample by chemical attack. An original image is composed of pixels representing a sample of an alloy, the fingerprints of the hydrides being represented by groupings of pixels. This method implements a process comprising steps for image processing, grouped within a step referred to as skeletization step, so as to obtain the skeleton of the groupings of pixels contained in the image. The skeletization step is followed by an analysis step applied to the groupings thus skeletized. The analysis step allows the indirect determination of the concentration of hydrogen together with the study of the morphology of the hydrides. This method is referred to as a semi-quantitative method, based on a comparison of the measurements with etalons, and notably has the drawback of not being applicable in the case of high concentrations of hydrides, typically greater than 1500 ppm, owing to the difficulty of separating, by computer processing, the fingerprints of the hydrides exhibiting such concentrations.

There exist other known methods, consisting in sintering the sample to be characterized in order to collect the hydrogen in gaseous form so as to subsequently analyze it, for example by using a gas detector with a detection limit of the order of a few tens of ppb, or else by gas spectrometry with a detection limit typically less than around ten ppb. However, drawbacks of these methods are notably that the latter only allow a global quantitative analysis, result in the destruction of the sample, and that they do not allow an elemental mapping of the sample.

Lastly, there exists a known method referred to as laser-induced plasma optical emission spectrometry, commonly denoted by the acronym LIBS corresponding to laser-Induced Breakdown Spectroscopy'. This method essentially consists in irradiating a sample with an intense pulsed laser beam, known as ‘ablation beam’, leading to the heating and to the ablation of the material in the form of a plasma. The analysis of the atomic and ionic emission lines of the radiation emitted by this plasma then allows its composition, which is correlated to that of the irradiated sample, to be determined. The sample is disposed on a platen which comprises means of precise displacement of the sample, allowing the distribution of the elemental concentrations to be determined, and thus an elemental mapping of the sample to be carried out. A device for elemental analysis using a LIBS method is for example described in the patent published under the reference FR 2800466. The LIBS method offers the advantage of being fast, contactless, and of not requiring an elaborate preparation of the sample, and of not requiring a measurement chamber, since the measurements can be carried out at atmospheric pressure.

One aim of the present invention is to overcome at least the drawbacks inherent in the various aforementioned known methods, by providing a device for the mapping of elements such as hydrogen and oxygen present in samples based on a method of laser-induced plasma optical emission spectrometry such as described in the aforementioned patent FR 2800466, the device according to the invention offering an increased resolution and sensitivity, and that is able to operate under normal environmental conditions, in other words notably under atmospheric pressure, thus reducing the hardware constraints and the setup time for the analysis.

One advantage of the invention is that it also allows the analysis of both insulating materials and of conducting materials.

Another advantage of the invention is that it allows the simultaneous analysis of several elements, for example hydrogen and oxygen.

For this purpose, the subject of the invention is a mapping and analysis device for at least one element of interest included in a solid sample by laser-induced plasma optical emission spectrometry, comprising:
a module for generating a pulsed laser beam associated with a beam conditioning system comprising at least one beam conditioning lens concentrating the energy of the beam through an aperture, a first collimating lens projecting the image of the aperture at infinity, a microscope image-forming optic focusing the image of the aperture onto the surface of the sample,
a collection, processing and analysis system for the optical signal coming from the radiation of a plasma generated on the surface of the sample comprising at least means for collection of the signal, means for measurement of the signal allowing a spectral analysis of the optical signal, and processing and analysis means allowing the analysis of the elemental composition of the sample,
   the mapping and analysis device being characterized in that the collection of the optical signal is carried out during a time window of given duration, and whose start time has a delay with respect to the pulses of the pulsed laser matched to the atomic emission line of the element of interest, and said given duration is matched to the lifetime of said atomic emission line, the elemental mapping being carried out by displacement of the sample synchronized with the pulses of the pulsed laser, the means for measurement of the signal being formed by at least one interference filter disposed on a photomultiplier, the interference filter allowing the frequencies to pass that are situated within a narrow band around the frequency corresponding to the wavelength of the emission line of the element of interest.

In one embodiment of the invention, the means for collection of the signal can be formed by an optical fiber one end of which is disposed near to the surface of the sample.

In one embodiment of the invention, the means for measurement of the signal can be formed by at least one spectrometer.

In one embodiment of the invention, the interference filter can be a dual-cavity filter.

In one embodiment of the invention, the interference filter can be disposed on the photomultiplier by means of a support comprising means for adjusting the orientation of the interference filter, adjusting the value of the central wavelength of the interference filter.

In one embodiment of the invention, the beam conditioning system can furthermore comprise means for adjusting the energy of the beam.

In one embodiment of the invention, the means for adjusting the energy of the beam can be formed by an attenuator.

In one embodiment of the invention, the size of interaction between the pulsed laser and the sample can be determined by the main dimension of the aperture, combined with the magnification of the microscope image-forming optic, the energy being adjusted via the means for adjusting the energy of the beam.

In one embodiment of the invention, the mapping and analysis device can furthermore comprise means for injecting gas substantially at the level of the surface of the sample where the plasma is generated.

In one embodiment of the invention, the means of injecting gas can comprise a first tube for the injection of helium.

In one embodiment of the invention, the means of injecting gas can furthermore comprise a second tube for the injection of argon.

In one embodiment of the invention, the mapping and analysis device can furthermore comprise means for the precise positioning of the sample.

In one embodiment of the invention, the mapping and analysis device can be designed for the mapping of hydrogen simultaneously with the mapping of oxygen, and comprise a collection, processing and analysis system adapted to the mapping of oxygen and a collection, processing and analysis system adapted to the mapping of hydrogen.

In one embodiment of the invention, the mapping and analysis device can furthermore comprise a collection, processing and analysis system adapted to the mapping of lithium, said means for measurement of the signal from said collection, processing and analysis system adapted to the mapping of lithium comprising a spectrometer.

Other features and advantages of the invention will become apparent upon reading the description, given by way of example, presented with regard to the appended drawings which show:

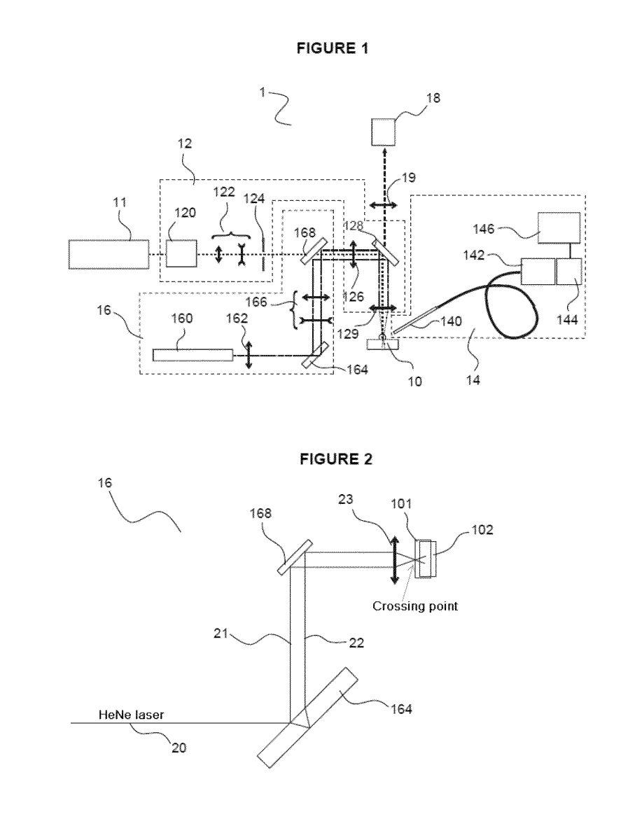

FIG. 1, a schematic diagram representing an elemental mapping device according to one embodiment of the invention;

FIG. 2, a diagram representing a focusing module forming a system for adjustment of the laser beam of a device according to one exemplary embodiment of the invention;

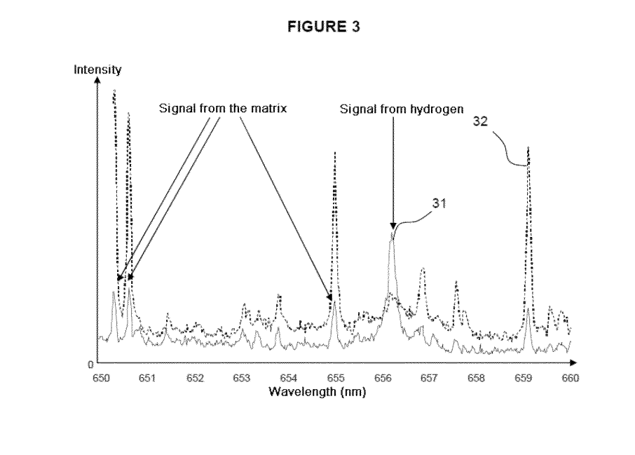

FIG. 3, curves illustrating the gain provided by the use of a flow of helium for the analysis of hydrogen;

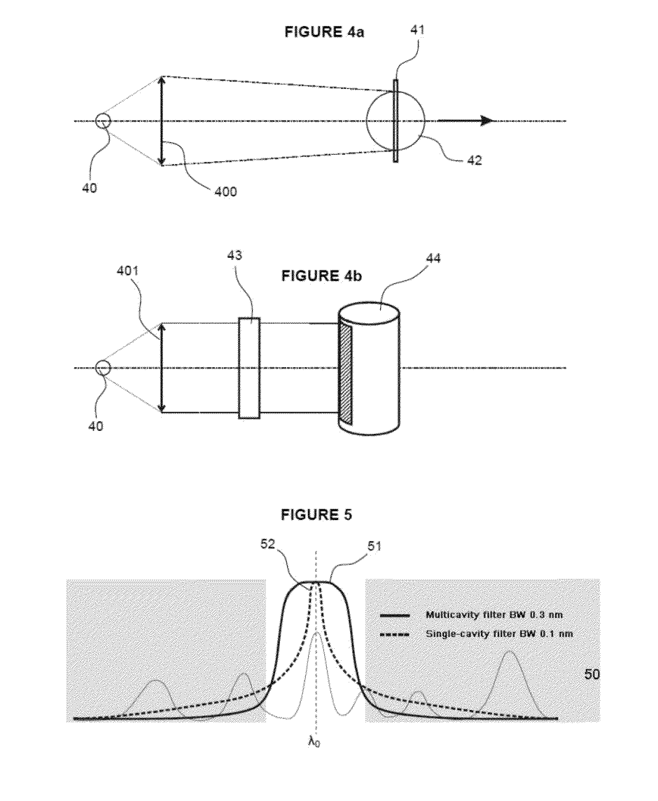

FIGS. 4a and 4b, schematic diagrams showing devices for coupling between an optical signal resulting from the plasma radiation, based respectively on a spectrometer and on an interference filter, according to one exemplary embodiment of the invention;

FIG. 5, curves illustrating the performance of an interference filter, used in one exemplary embodiment of the invention;

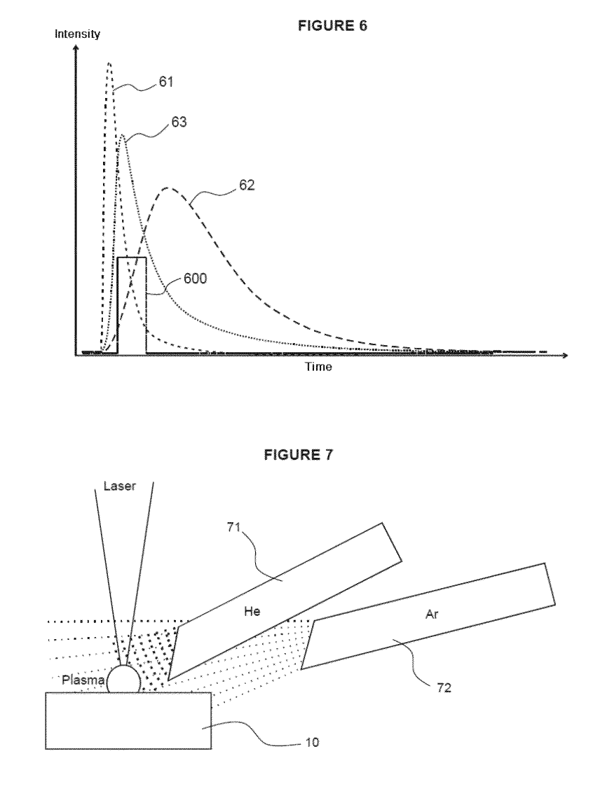

FIG. 6, curves illustrating the time variation profiles of the emission signals coming from the radiation by the plasma, with regard to a measurement time window, according to one exemplary embodiment of the invention;

FIG. 7, a diagram illustrating the application of a gas jet on a sample under analysis, in one exemplary embodiment of the invention.

FIG. 1 shows a diagram representing schematically an elemental mapping device according to one embodiment of the present invention.

A device 1 for elemental mapping of a sample 10 disposed on a support, not shown in the figure, can comprise, in one exemplary embodiment of the invention, a module for generating a pulsed laser beam 11 associated with a first beam conditioning system 12. The elemental mapping device 1 also comprises a system 14 for the collection, processing and analysis of the optical signal coming from the plasma radiation generated on the surface of the sample 10.

Advantageously, the elemental mapping device 1 can comprise a focusing module 16 allowing a precise adjustment of the impact of the laser beam on the sample 10, in association with a display system comprising for example a camera 18 associated with an optical system 19.

The module for generating a pulsed laser beam 11 can for example emit a laser beam with a wavelength in the ultraviolet domain, for example around 266 nanometers. The duration of the pulses can be of the order of a few nanoseconds, for example 4 ns.

The beam conditioning system 12 can comprise means for adjusting the energy of the beam 120 that can be formed by an attenuator, for example a semi-reflecting compensating attenuator, allowing the reflection of a part of the beam by an appropriately designed semi-reflecting mirror in combination with a simple antireflecting plate compensating for the deviation of the beam, or else by one or a plurality of polarizers, plates with a half-wavelength delay being disposed between two polarizers. A beam conditioning lens or telescope 122 can be disposed downstream of the means for adjusting the energy of the beam 120, and allows the energy of the beam to be concentrated through an aperture 124, together with the adjustment of the divergence of the beam at the exit of the aperture 124. A first collimating lens 126 is disposed downstream of the aperture 124. The first collimating lens 126 can for example be formed by a converging compound lens projecting the image of the aperture 124 at infinity. A microscope image-forming optic 129 allows the image of the aperture 124 to be produced on the surface of the sample 10. The first collimating lens 126 has an appropriate focal length for obtaining a magnification sufficient in combination with the microscope image-forming optic 129. It is furthermore advantageous for the microscope image-forming optic 129 to provide a working distance that is sufficient to allow the installation of all the required instrumentation around the plasma, in other words, typically of the order of a few millimeters. In addition, the numerical aperture of the microscope image-forming optic 129 must be as large as possible in order to obtain the best possible laser-matter interaction. Typically, but in a non-limiting manner, for the present invention, the numerical aperture of the microscope image-forming optic 129 can for example be fixed at 0.32.

The beam conditioning system 12 thus allows a laser beam profile to be formed on the surface of the sample 10 of the type commonly referred to as “top hat”, in other words exhibiting a virtually uniform energy density within the disk of the impact with the material. Such a profile offers the advantage of limiting the variations in diameter of the ablation crater created, and allows the size of the laser-matter interaction to be controlled.

It is to be observed that the size of the plasma depends on the energy deposited on the surface of the sample 10. The larger the size of the plasma, the greater the participation of the latter in the erosion of the surface of the sample 10, which could have a negative impact on the desired resolution. The energy of the laser must therefore be adjusted in such a manner as to obtain a plasma emitting sufficient light to be measured, while at the same time maintaining a size small enough so as not to significantly widen the crater formed. Typically, when the matrix of the sample is for example essentially composed of Zirconium, Iron or Aluminum, the energy of the laser beam at the exit of the aperture 124 can be fixed at less than 2.5 μJ for a desired resolution of around 1 to 2 μm, the energy can be fixed at 3 to 4 μJ for a desired resolution of around 3 μm, at around 6 μJ for a desired resolution of 5 μm, and at more than 15 μJ, up to energies of around 100 to 200 μJ, for desired resolutions greater than 10 μm. These values may be substantially different when the matrix of the sample is essentially composed of different materials, such as Copper, Lead or Tin, having lower melting points or a higher thermal conductivity. It should however be noted that the illumination on the sample 10 should preferably remain above 1 GW/cm², as is commonly the case, and more preferably be of the order of ten GW/cm².

The microscope image-forming optic 129 can be reflective or refractive, and allow the use of a high-energy pulsed laser beam. It can be advantageous to choose a refractive image-forming optic for resolutions less than 5 μm, the optical resolution of image-forming optics of the refractive type being better than that of image-forming optics using mirrors, for example of the Cassegrain or Schwarschild type.

In order to obtain a better resolution, the diameter of the laser beam must optimally cover the pupil of the optical system formed by the first collimating lens 126 and the microscope image-forming optic 129. This can be carried out by an adjustment of the divergence of the laser beam via the beam conditioning lens 122.

Advantageously, a dichroic mirror 128 designed for the wavelength of the laser can be disposed between the first collimating lens 126 and the microscope image-forming optic 129, in such a manner as to allow the observation of the sample 10 through the microscope image-forming optic 129, for example via the camera 18 associated with the camera optical system 19.

The system 14 for collection, processing and analysis of the optical signal coming from the radiation of the plasma generated on the surface of the sample 10 can comprise means for collection of the signal 140, for example formed by a lens, a mirror, or else an optical fiber. The signal can also be collected through the microscope image-forming optic 129. A collection via an optical fiber allows a greater flexibility, since the end of the optical fiber can be placed in the immediate vicinity of the plasma. The means for collection of the signal 140 may for example consist of an optical fiber with a diameter of 1 millimeter, placed in the immediate vicinity of the plasma, at a typical distance of around 2 millimeters. Such a device allows the signal to be collected with the whole aperture of the optical fiber, typically of around 0.22, without having to make use of additional optical means. The use of such a device is made possible owing to the very small size of the plasma, typically much smaller than 1 millimeter.

The spectral analysis of the signal can be provided by means for measurement of the signal 142, for example a spectrometer. The collection, processing and analysis system 14 can furthermore comprise processing and analysis means 144 allowing an analysis of the elemental composition of the sample, where the processing and analysis means 144 could be associated with suitable electronics 146, and connected to the means for measurement of the signal 142. The processing and analysis means 144 can for example comprise a camera, for example a video camera with a sensor of the intensified CCD type, or else a photomultiplier.

Since the optical signal is of a transient nature, the collection is thus carried out by means of pulsed electronics synchronized with the pulses of the ablation laser. Advantageously, with the aim of allowing the extraction of the most useful part of this signal, the measurement can be performed with a delay matched to the atomic emission line of interest, following the laser pulse and during a time window whose duration is adapted to its lifetime, where this time window can be denoted “time resolution”. Indeed, in the first moments of the life of the plasma, there exists an emission continuum compromising the exploitation of the signal. Then, when the plasma has cooled, the emission of lines becomes too weak to be used, and it is then no longer useful to carry out the detection of the signal. The measurement time window is described in more detail hereinafter, with reference to FIG. 5.

In practice, a measurement cycle can consist of a laser pulse causing the ablation of the material from the sample to be analyzed, and the formation of the plasma. The acquisition of the signal by the collection, processing and analysis system 14 can be triggered by the laser pulse. At the end of the measurement time window, the sample can be moved to the position for the next pulse. The process can then be repeated as many times as is needed in order to obtain a complete image of the sample. In the case where several elements are analyzed simultaneously, as is described hereinafter in one exemplary embodiment of the invention.

It is also possible to move the sample in a continuous manner, and to trigger the laser shot when the displacement made corresponds to the desired distance between the measurement points.

According to one feature of the present invention, in order to carry out a measurement on very small quantities of light with very fine resolutions, of around 1 to 2 μm, it is possible to form the means for measurement of the signal 142 via an interference filter rather than by a spectrometer, the interference filter being placed on a photomultiplier. The use of a filter is particularly advantageous for resolutions typically less than 2 μm because the plasma being very small, of the order of a hundred micrometers, emits very little light. The interference filter then allows collection of the signal with a minimum of losses. The use of an interference filter compared to that of a spectrometer is described in detail hereinafter with reference to FIGS. 4a and 4b illustrating exemplary embodiments.

A mapping and elemental analysis device according to one of the embodiments described can advantageously be applied not only to oxygen and to hydrogen but also to all the elements, as long as their emission lines are sufficiently isolated or the time parameters of the latter are sufficiently different from those of the emission lines of the spurious sources, in such a manner that their influence on the signal of interest can be reduced by an appropriate adjustment of the time parameters of the measurement.

With the aim of obtaining a diameter of laser-matter interaction of the order of a micrometer, it is necessary for the positioning of the sample 10 under the image plane of the aperture 124 to be very precise. Thus, for desired diameters typically less than around 4 μm, a focusing to the nearest 1 μm is required. The aforementioned focusing module 16 allows such a precision to be attained. The focusing module 16 can comprise a laser beam generator 160, for example of the Helium-Neon type, a focusing lens 162, a beam divider 164, for example formed by a thick glass plate with parallel faces have two glass-interface reflections, allowing a division of the laser beam into two parallel beams. The two resulting beams are placed on the path of the ablation beam by means of a mirror 168, which may be mobile or otherwise. A telescope 166 can be disposed downstream of the beam divider 164, and allows the adjustment of the point where the two beams intersect on the sample 10 when the latter is situated on the image plane of the aperture 124. The operation of the focusing module 16 is described in detail hereinafter with reference to FIG. 2.

The means for the precise positioning of the sample 10 described hereinabove are mentioned by way of example, and other means for precise positioning of the sample 10, known per se from the prior art, may be envisaged.

FIG. 2 shows a diagram illustrating a focusing module 16 forming a system for focusing the laser beam of a device according to one exemplary embodiment of the invention.

For the sake of clarity of the description, FIG. 2 does not show the dichroic mirror 128, and the sample is thus shown here directly downstream of the mirror 168. In addition, the telescope 166 is not shown in FIG. 2. An optical device 23 is shown downstream of the mirror 168, and notably comprises the elements such as the first collimating lens 126, the dichroic mirror 128 and the microscope image-forming optic 129, with reference to FIG. 1 previously described. The mirror 168 is thus shown directly downstream of the beam divider 164. The beam 20 from the Helium-Neon laser is divided into two separate and parallel beams 21 and 22 by the beam divider 164. The sample is shown in the figure in two different positions: a first position 101 corresponding to a correct placement of the sample, and a second position 102 corresponding to an out-of-focus placement of the sample.

The adjustment of the focusing of the laser beam on the sample can be carried out in the following manner: the polished sample can be placed under the ablation microscope, and its position can be adjusted until the smallest crater is obtained exhibiting the best possible defined edges. The monitoring of these parameters can for example be carried out by means of an optical profilometer. The telescope 166 can then be adjusted in such a manner that the two spots produced by the two beams 21, 22 visible on the surface of the sample are superimposed. The sample is thus correctly placed when, as in the case of the first position 101, the two spots are superimposed. If two spots are visible on its surface, as in the case of the second position 102 illustrated in the figure, then the sample is out of focus. For the following part of the mapping of the sample, the latter can be systematically placed in such a manner that these two spots are superimposed. Means of automatic adjustment can be advantageously envisaged, and can control the movement of the sample by a closed-loop control of means for measuring the distance separating the two spots. The sample can be disposed on a platen with gimbal adjustment, and the focusing module 16 also allows the orientation of the sample to be adjusted so that its surface is parallel to the plane image of the aperture 124, with reference to FIG. 1.

The displacements of the sample can be provided by micrometer positioning platens offering a precision of at least 0.1 μm. The speed of displacement of the sample must allow the cadence of the pulsed ablation laser to be followed, for example of the order of 10 Hertz. Typically, a cadence of the order of 300 measurement points per second can be reached.

The plasma obtained in a device according to one of the embodiments of the invention is of very limited size, and has a low luminosity. It is known that the atmospheric environment of the plasma has a very significant influence on its luminosity and on its lifetime.

It is also known that argon notably allows an increase of the order of a factor 10 to 100 in the emitted signal. Thus, according to techniques known per se from the prior art, it can be envisaged to supply a flow of argon around the plasma. Such a technique is for example described in the aforementioned patent FR 2800466. However, the increase does not occur in the case of hydrogen, or again only occurs weakly in the case of oxygen.

According to one feature of the present invention, a flow of helium is supplied to the plasma, with the aim of increasing the emitted signal.

As far as the element hydrogen is concerned, the intensity of the hydrogen Hα line, situated at a wavelength of 656.28 nm, is relatively weak, and practically invisible in an air or argon atmosphere. The use of a flow of helium allows the intensity of this emission line to be increased, by a factor greater than 3. The flow of helium simultaneously allows the intensity of the background and of the other lines characteristic of the matrix to be considerably reduced, thus improving the signal to background noise ratio.

FIG. 3 illustrates the gain provided by the use of a flow of helium for the analysis of hydrogen. The characteristics of the intensity of the signal emitted around the wavelength corresponding to the hydrogen Hα line are shown in a reference frame where the wavelength is plotted as abscissa and the intensity of the emitted signal as ordinate. A first curve 31, the solid line in the figure, represents the intensity of the emitted signal in the case where a flow of helium is used, and a second curve 32, the dashed line in the figure, represents the intensity of the emitted signal in the case where a flow of argon is used. The two curves 31, 32 highlight the gain in intensity offered by the use of the flow of helium, allowing a selective increase in the intensity of the signal corresponding to the Hαemission line of hydrogen, while at the same time reducing the intensity of the background and of the other lines characteristic of the matrix which can be detrimental to the measurement, as can be the case with the use of the flow of argon, as is illustrated by the second curve 32.

Another feature of the present invention allows the resolution to be even further improved. The gain obtained by the use of a flow of helium indeed remains limited, if it is desired to obtain a sufficiently bright plasma for the analysis of hydrogen typically at a resolution of less than 3 μm. It is relatively easy to reduce the interaction size, however this leads to a very small plasma that is insufficiently bright to enable a satisfactory detection. The solution proposed by the present invention is to increase the quantity of light collected by the means for measurement of the intensity of the signal 142, in order to obtain a signal with a sufficient intensity and consequently a better spatial resolution.

This is made possible by an adjustment of the spatial resolution by combining a size of aperture 124 that is sufficiently small to obtain a sufficiently fine size of interaction, of the order of 1 to 2 μm, with an appropriate magnification by the microscope image-forming optic 129, and a sensibly chosen energy of the laser. It is for example possible to use an aperture of 50 μm combined with a magnification of 60, so as to obtain a resolution of the order of 1 μm, this value being limited by the diffraction limits of the optical system. A compromise can for example be found, under the previous conditions of magnification and of size of aperture, with an energy of the laser of around 3 μJ at the exit of the aperture 124, this being around 2 μJ on the sample.

FIGS. 4a and 4b show diagrams illustrating schematically devices for coupling between an optical signal resulting from the plasma radiation, based respectively on a spectrometer and on an interference filter, according to one exemplary embodiment of the invention.

In the first case, illustrated in FIG. 4a, where the means for measurement of the signal 142 are formed by a spectrometer comprising a slit 41, the optical signal coming directly from the plasma, or else at the exit of the means for collection of the signal 140, for example an optical fiber 40, an adaptor lens 400 must be used allowing the aperture of the light source to be adapted with respect to the spectrometer. An image 42 of the exit of the optical fiber 40 is formed at the spectrometer. Since the collection of the light signal by the optical fiber 40 is basically optimized, the fiber-spectrometer coupling must be improved. This coupling is limited by the small aperture and the limited size of the slit 41 of the spectrometer, in comparison with the diameter and with the aperture of the optical fiber 40. Typically, by using a spectrometer open at F/10.5, and presenting a numerical aperture of 0.047, with a slit 41 of 100 μm coupled to an optical fiber 40 with a 1 mm diameter and with a numerical aperture 0.22. The magnification to be applied, respectively corresponding to the ratio of the numerical apertures of the optical fiber 40 and of the spectrometer, is equal to 4.6. Thus, the diameter of the image 42 of the fiber 40 at the spectrometer is equal to 4.6 mm, or a surface area of 16.6 mm². Since the useful surface area of the slit 41 is only 0.46 mm², the loss of the signal by the fiber-spectrometer coupling thus goes up to a factor of 36.

As is illustrated in FIG. 4b, one solution provided by the present invention consists in using an interference filter 43 between a second collimating lens 401 and a photomultiplier 44. The bandwidth of the interference filter 43 must be chosen to be as narrow as possible. Thus, the light coming from the exit of the optical fiber 40 is collimated by the second collimating lens 401, whose diameter is chosen to be sufficient for capturing the whole beam. The resulting light beam passes through the interference filter 43 and illuminates the photomultiplier 44, the interference filter 43 forming a window which does not affect the optical geometry of the assembly. Consequently, there is no loss of light during the coupling. Only the losses due to the reflections on the faces of the second collimating lens 401 and the transmission of the interference filter 43 limit the performance.

The interference filter 43 can for example be a dual-cavity filter, in such a manner as to offer the most selective cutoff possible around the central wavelength of the signal of interest, for example 656.2 nm for the hydrogen Hα line, while at the same time maintaining a high transmission of the order of 35%.

The interference filter 43 can be placed on the photomultiplier 44 by means of an appropriate support. Advantageously, the support of the interference filter 43 can comprise adjustment means, allowing the orientation of the interference filter 43 to be adjusted with the aim of adjusting the value of the central wavelength of the latter, for example in order to compensate for manufacturing tolerances of the interference filter 43.

For example, the interference filter 43 may be chosen with a bandwidth of 0.3 nm. This value of bandwidth may be preferred over a lower value, for example 0.1 nm, so that the maximum extent of the width of the hydrogen emission line is used. Furthermore, a filter with a bandwidth of 0.1 nm is a single-cavity filter, and the edges of the cutoff band are then quite spread out around the central wavelength; as a result, the selectivity offered by a filter with a bandwidth of 0.1 nm is not significantly better than with the 0.3 nm filter, which has a higher transmission.

These phenomena are illustrated in FIG. 5 described hereinafter, showing curves illustrating the time variation profiles of the emission signals coming from the radiation by the plasma, as viewed in the measurement time window.

In FIG. 5, a first curve 50 represents with a fine line the intensity of the optical emission signal as a function of the wavelength, around a central wavelength λ₀.

A second curve 51 represents with a thick line the transmission characteristic of a multi-cavity interference filter 43, with a bandwidth of 0.3 nm, and a third curve 52 represents with a dashed line the characteristic of a single-cavity interference filter 43, with a bandwidth of 0.1 nm. Two shaded areas in the figure show the regions in which the influence of the contribution of the emission signals of the matrix and of the background is the most significant. It can be seen in FIG. 5 that the contribution of the emission signals of the matrix and of the background is most sensitive in the case of the use of a single-cavity interference filter 43. Furthermore, the uncertainty on the value of the central wavelength of the interference filter 43 is less of a problem for a filter with a wider bandwidth.

In the case of hydrogen, the use of the interference filter 43 allows the quantity of light collected to be increased by at least a factor 30.

However, the spectral selectivity turns out to be limited with respect to the spectral selectivity provided by a spectrometer. The present invention aims to overcome the problem of spectral selectivity by a shrewd exploitation of the difference in lifetime of the hydrogen line, in comparison with the lines of the matrix and of the continuum background.

FIG. 6 shows curves illustrating the time variation profiles of the emission signals coming from the radiation by the plasma, as viewed in the measurement time window, in one exemplary embodiment of the invention. All the curves shown in the figure are shown in a Cartesian reference frame on whose abscissa time, and on whose ordinate the intensity of the emission signal are plotted.

A first curve 61 represents with a dashed line the intensity of the signal associated with the emission of the continuum. A second curve 62 represents with a dashed line the emission associated with the matrix. A third curve 63 represents with a dashed line the emission associated with the element of interest, i.e. hydrogen in this example. A fourth curve 600 represents the characteristic of a measurement port, defining the aforementioned measurement time window.

As is illustrated in the figure, the emission line of hydrogen, represented by the third curve 63, only lasts for a very short time with respect to the other emission lines represented by the first and second curves 61, 62. According to one feature of the present invention, the idea is to adjust the delay of the measurement port, this being the moment that the time window opens, by referring for example to a reference time which can be the start of the pulse of the ablation laser, so as to minimize as far as possible the contribution of the continuum, without however causing too large a loss of signal on the emission line of hydrogen. The duration of the measurement time window can be adjusted in order to make maximum use of the duration of the hydrogen emission line, while at the same time reducing the spectral component due to the undesirable lines, associated for example with the emission of the elements constituting the matrix of the sample, such as Iron, Zirconium, etc. In other words, the measurement time window is defined so as to maximize the signal from the hydrogen while at the same time increasing the Hydrogen—Background contrast as much as possible, the background being understood to comprise the emission lines of the elements constituting the matrix and of the continuum.

Advantageously, a practical configuration for analysis of the element hydrogen can define a measurement time window whose delay with respect to the pulse of the ablation laser is around 20 to 30 ns, and whose duration is around 30 to 40 ns. These values can be modified as a function of the energy delivered by the ablation laser, notably, when a less fine resolution, for example of the order of 10 μm, is sufficient, and when it is possible to increase the energy of the ablation laser in order to obtain a signal of higher intensity. In such a case, where the dimension of the plasma is larger and its radiation is of longer duration, the delay and the duration of the measurement time window can then be adapted to the resulting lifetime of the emission line of the hydrogen.

Typically, with a configuration described by way of example hereinabove, the quantity of light collected by the photomultiplier 44 is such that the latter can be used with a relatively low power supply voltage of around 800 to 1000 Volts, which allows a further improvement in the signal-to-noise ratio.

The elemental mapping of hydrogen at high spatial resolution, such as implemented according to one of the embodiments of the invention described hereinabove, is thus based on a combination between the size of the aperture, the adjustment of the energy of the ablation laser beam, the use of an interference filter with an appropriate bandwidth, and the adjustment of the measurement time window in order to overcome the lack of resolution of the interference filter. As is described hereinabove, the combination between the size of the aperture and the energy of the pulsed laser allows a size of interaction of around 1 to 2 μm to be obtained, while at the same time controlling the effect of the plasma on the diameter of the crater, the latter defining the maximum allowable resolution. The use of an interference filter allows the efficiency of the optical transmission chain to be improved and provides a gain of around 50 on the quantity of light collected. The adjustment of the parameters of the measurement time window allows the influence of the emission lines of the matrix and of the continuum to be reduced. The adjustment of the parameters of the time window is normally used in the prior art to optimize the signal-to-noise ratio; according to the present invention, the adjustment of the parameters of the time window allows the influence or the contribution of interfering elements to be eliminated. This possibility is particularly advantageous notably when the element to be measured possesses a line that emits earlier than the interfering element and when its lifetime is short with respect to this same element, which is for example the case for hydrogen. The adjustment of the parameters of the time window according to the present invention thus allows a good spectral selectivity to be achieved despite the use of a combination of an interference filter and a photomultiplier.

Another advantage provided by a mapping device according to one of the embodiments of the present invention is that it is particularly compact and relatively low cost.

The description hereinabove is notably applicable to the element hydrogen. As far as the mapping and the analysis of the element oxygen or of other elements is concerned, notably the light elements, the mapping device according to one of the embodiments previously described can also be employed.

With particular regard to oxygen, the interference filter 43 can be set to the lines of wavelength 777 nm. At this wavelength, or at neighboring wavelengths, few interfering elements exist. Thus, an interference filter 43 having a wider bandwidth, for example of around 0.5 nm, may be used offering the advantage of being less costly relative to an interference filter with a narrower bandwidth. The constraints in terms of duration of the measurement time window are also less severe, because the oxygen emission lines have a longer lifetime than those of hydrogen. It is possible to define the measurement time window with parameters quite close to those used for hydrogen, for example: a delay of around 25 to 35 ns, and a duration of around 30 to 40 ns, these parameters being able to be modified according to the energy of the ablation laser.

As far as notably oxygen is concerned, the optical signal emanating from the plasma radiation can also be increased by the use of a helium jet, as has been described hereinabove. However, one problem posed by the measurement of oxygen without a confinement vessel is associated with the presence of air. Also, since helium is a very light gas, it does not allow the ambient air to be sufficiently eliminated, which results in oxidation of the particles ejected by the ablation. The latter are subsequently re-deposited onto the surrounding surface and will be undesirably re-analyzed by the subsequent laser shots. The quantity of oxygen in the air trapped in the oxides of the elements constituting the matrix, for example oxides of Iron, of Zirconium, etc., can become non-negligible with respect to the oxygen present in the sample itself. This results in an extremely noisy image which may be unusable. In order to overcome this problem, the present invention advantageously includes the addition of a flow of argon to the flow of helium, as is illustrated in FIG. 7.

FIG. 7 shows a diagram illustrating the application of a gas jet on a sample under analysis, in one exemplary embodiment of the invention.

FIG. 7 shows a cross-sectional view illustrating schematically the configuration of means for injecting gas onto the surface of the sample 10. A first tube 71 can allow the injection of a flow of helium or of argon substantially into the plasma generated by the ablation laser on the surface of the sample 10. The gas can for example be supplied to first tube 71 via a reservoir of pressurized gas, for example according to a continuous flow throughout the measurement. Advantageously, the flow of gas can be controlled by a valve which is operated by an open command at the start of the measurement, and by a close command at the end of the measurement. In a device also designed for the mapping of oxygen, it is advantageously possible to add to the first tube 71, as has been previously described, a second tube 72 allowing the injection of argon in a similar manner. The second tube 72 can for example be disposed upstream of the first tube 71 for injection of helium. The means for injection of argon are thus disposed further back than the means for injection of helium and allow the surface of the sample to be covered by gas. The injection of argon allows the ambient air to be blown away and the oxidation of the ejected particles to be limited as much as possible.

Typically, the first tube 71 of helium or of argon can be placed at around 200 μm from the surface of the sample, according to an angle of incidence of around 20 to 30°, and at a distance of the order of a millimeter from the plasma. In the case where the second tube 72 is used, the second tube 72 can be disposed further back than the first tube 71, at a distance of around a few centimeters from the latter, with an angle of incidence with respect to the surface of the sample less than the angle of incidence presented by the first tube 71.

The values previously mentioned are typical values mentioned by way of non-limiting examples of the present invention.

It is advantageously possible to enable the simultaneous mapping of hydrogen and of oxygen, by disposing two optical fibers and two means for measurement of the signal 142 each comprising an interference filter 43 and a photomultiplier 44.

Advantageously again, a third optical fiber may be added to a device according to one of the embodiments of the invention described hereinabove, in order for example to enable the elemental mapping of lithium simultaneously with the elemental mapping of hydrogen and/or oxygen. The simultaneous mapping of hydrogen, of oxygen and of lithium can thus be rendered possible without requiring the deployment of costly devices and processes.

With regard to lithium, notably when the latter must be detected in very low concentrations, of the order of 10 ppm, a spectrometer may be preferred to a photomultiplier associated with an interference filter. The reason for this is that there exist interfering emission lines very close to the emission line of Lithium situated at a wavelength of 670 nm.

It should be noted that particularly surprising performance characteristics in terms of resolution can be achieved by a device according to the present invention, by the combined use of the interference filter 43, with the appropriate definition of time parameters for the measurement time window, together with the injection of gas onto the surface of the sample.

1. A device for mapping and for analysis of at least one element of interest included in a solid sample by laser-induced plasma optical emission spectrometry, comprising:
a module for generating a pulsed laser beam, a beam conditioning system comprising at least one beam conditioning lens concentrating the energy of the beam through an aperture, a first collimating lens projecting the image of the aperture at infinity, a microscope image-forming optic focusing the image of the aperture onto the surface of the sample,
a collection, processing and analysis system for the optical signal coming from the radiation of a plasma generated on the surface of the sample comprising at least means for collection of the signal, means for measurement of the signal allowing a spectral analysis of the optical signal, and processing and analysis means allowing the analysis of the elemental composition of the sample
the mapping and analysis device being configured such that the collection of the optical signal is carried out during a time window of given duration, and whose start time has a delay with respect to the pulses of the pulsed laser matched to the atomic emission line of the element of interest so as to reduce as far as possible the contribution of the continuum, and said given duration is adapted so as to take maximum advantage of the lifetime of said atomic emission line, the elemental mapping being carried out by displacement of the sample synchronized with the pulses of the pulsed laser, the means for measurement of the signal being formed by at least one interference filter disposed on a photomultiplier, the interference filter allowing the frequencies to pass that are situated within a narrow band around the frequency corresponding to the wavelength of the emission line of the element of interest.

2. The mapping and analysis device as claimed in claim 1, in which the means for collection of the signal are formed by an optical fiber one end of which is disposed near to the surface of the sample.

3. The mapping and analysis device as claimed in claim 1, in which the means for measurement of the signal are formed by at least one spectrometer.

4. The mapping and analysis device as claimed in claim 3, in which the interference filter is a dual-cavity filter.

5. The mapping and analysis device as claimed in claim 1, in which the interference filter is disposed on the photomultiplier by means of a support comprising means for adjusting the orientation of the interference filter, and adjusting the value of the central wavelength of the interference filter.

6. The mapping and analysis device as claimed in claim 1, in which the beam conditioning system furthermore comprises means for adjusting the energy of the beam.

7. The mapping and analysis device as claimed in claim 6, in which the means for adjusting the energy of the beam are formed by an attenuator.

8. The mapping and analysis device as claimed in claim 6, in which the size of interaction between the pulsed laser and the sample is determined by the main dimension of the aperture, combined with the magnification of the microscope image-forming optic, the energy being adjusted via the means for adjusting the energy of the beam.

9. The mapping and analysis device as claimed in claim 1, furthermore comprising means for injecting gas substantially at the level of the surface of the sample where the plasma is generated.

10. The mapping and analysis device as claimed in claim 9, in which the means of injecting gas comprise a first tube for the injection of helium.

11. The mapping and analysis device as claimed in claim 9, in which the means of injecting gas furthermore comprise a second tube for the injection of argon.

12. Mapping and analysis device as claimed in claim 1, furthermore comprising means for the precise positioning of the sample.

13. Mapping and analysis device as claimed in claim 1 designed for the mapping of hydrogen simultaneously with the mapping of the oxygen, comprising a collection, processing and analysis system adapted to the mapping of oxygen and a collection, processing and analysis system adapted to the mapping of hydrogen.

14. Mapping and analysis device as claimed in claim 1, furthermore comprising a collection, processing and analysis system adapted to the mapping of lithium, said means for measurement of the signal from said collection, processing and analysis system adapted to the mapping of lithium comprising a spectrometer.

15. The mapping and analysis device as claimed in claim 1, designed to analyze hydrogen, said delay being in the range between 20 and 30 ns, and said given duration being in the range between 30 and 40 ns.

16. The mapping and analysis device as claimed in claim 1, designed to analyze oxygen, said delay being in the range between 25 and 35 ns, and said given duration being in the range between 30 and 40 ns.
